(19) United States
(12) Patent Application Publication
(10) Pub. No.: US 2006/0090072 A1
(43) Pub. Date: Apr. 27, 2006

(54) Computer system, management computer and data management method

(76) Inventors: Masayasu Asano, Yokohama (JP); Takayuki Nagai, Kawasaki (JP); Yasunori Kaneda, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/039,807

(22) Filed: Jan. 24, 2005

(30) Foreign Application Priority Data
Oct. 27, 2004 (JP) 2004-312937

(51) Int. Cl. H04L 9/00

(52) U.S. Cl. 713/168

(57) ABSTRACT

With respect to an administrator in a data management system, although an authority to see contents of data is not granted depending on a job of the administrator, it is necessary to acquire information of a volume in order to replicate the data on a computer in a job such as a replication of the data at the time of managing a storage system, and since the data can also be operated by the administrator who replicates the data, there is a problem from the view point of security.

A volume to encrypt and decrypt is determined by a user management program 112 of a management computer 100 according to a user's job. Further, as to whether to encrypt or whether to decrypt, a command of yes/no of the encryption and decryption is given to an encryption apparatus in accordance with the authority in an application of the user so as to perform the job such as performing the data replication by the encrypted data. Moreover, when it seems not possible to judge the encryption and decryption by the encryption apparatus, a path is set up without passing through the encryption apparatus so as to have a host recognize the data as is encrypted.

### BACKROUND

The present invention relates to a data management system which performs data management, wherein an operation of the data management is made possible by performing encryption and decryption of data in accordance with an authority in a user's application over a use of a data area of a storage apparatus (hereinafter, also referred to as a storage) while realizing a data protection according to the user's authority.

With increase in an amount of data of a storage in a computer system which is operated and managed in a business enterprise or the like, there has been increasing a computer system using a large-capacity storage and also a computer system wherein a plurality of storages are connected by SAN (Storage Area Network) which is a network (mainly Fibre Channel) exclusive to the storage or IP (Internet protocol) which connects among the plurality of storages such that the computer can share and use an large volume of data distributed over those storages. In such computer system as mentioned in the above, there is a tendency that due to increase in an amount of data to be managed, users who manages the data, namely administrators, also increase in proportion to the amount of data to be managed.

Moreover, with a storage system becoming large-scale, various data is made to be handled by the storage system which is connected in the SAN or IP environment, and therefore it is also considered that those data from data which is important to data which is regarded not so important coexist in the system. In case of the data which is important, there arises necessity for protecting data such as restricting the users who handle the data. In the past, the data protection has been mainly performed by setting a password for operating the data in a host and also by performing the encryption between the networks for data communication. Even in a storage network environment such as the SAN, there has been emerging a technology which performs the encryption of the data so as to protect the data.

In the patent reference 1, the encryption is performed between the networks of the SAN so as to strengthen security of a network portion on the SAN.

In the patent reference 2, in an environment which is set by determining a storage and a host which can be referred to (may be called zoning) inside a network of the SAN, a common code key is provided to the host and the storage to which the zoning is made. Then, when each volume data which is used in the zoning is downloaded for backup or the like into a storage or a tape which is common to a plurality of zonings, it is made not possible to refer to the volume data unless the code key in the common zone is used in order to decrypt the data in this storage or tape, and thereby a system environment of high data security is made possible.

[Patent reference 1] Japanese Patent Application Laid-open Publication No. 2002-217887

[Patent reference 2] Japanese Patent Application Laid-open Publication No. 2002-351747

There is a following problem in such prior-art methods.

In the technologies to improve the data security described in the two patent references which are listed in the related art, attention is paid only to a connection status of an apparatus of each system, and a viewpoint of the users who use the system is not considered. Under such circumstances, even an administrator to whom a reference authority of the data is not granted needs to operate by decrypting the encrypted data in an ordinary manner such that it is shown to the administrator in order to perform a system operation of backup or the like, for example. Due to the above, it will give such an environment that even the administrator to whom the reference authority of the data should not be actually granted can operate the data.

### SUMMARY

In order to solve the above stated problem, according to the present invention, a user's application is also made into an object as an criterion of performing encryption of data so as to decide whether the data encryption is performed in a storage system. Further, with respect to whether to encrypt or whether to decrypt, a command of the encryption or the decryption is given automatically to a encryption-decryption apparatus according to the user's application.

Moreover, when the decryption or the encryption can not be changed over per unit of volume in the encryption-decryption apparatus, a host is made to recognize the data as is encrypted by setting up a path between a volume and a host without passing through the encryption-decryption apparatus.

The encryption and decryption of the data is judged in accordance with the operation authority in user's application of the volume, and on that basis an operation of a data management system can be performed so as to improve a data protection function of the data management system.

### BRIEF DESCRIPTION OF THE DRAWINGS

FIGS. 1A and 1B are one example of diagrams showing a configuration of a data management system in an embodiment of the present invention;

FIGS. 2A and 2B are one example of diagrams showing a configuration of a table which is used in the data management system in an embodiment of the present invention;

FIGS. 3A and 3B are one example of flow charts showing a procedure of judging yes/no of decryption and setting a path in an embodiment of the present invention;

FIG. 4 is one example of a flow chart showing a procedure of judging yes/no of decryption and setting a path in an embodiment of the present invention;

FIGS. 5A and 5B are one example of diagrams showing a configuration of a data management system in an embodiment of the present invention;

FIG. 6 is one example of a diagram showing a configuration of a table which is used in the data management system in an embodiment of the present invention;

FIG. 7 is one example of a flow chart showing a procedure of judging yes/no of decryption and performing a data replication in an embodiment of the present invention; and

FIG. 8 is one example of a flow chart showing a procedure of judging yes/no of decryption and performing a data restoration in an embodiment of the present invention.

### DESCRIPTION OF THE PREFERRED EMBODIMENTS

Hereinafter, a preferred embodiment to implement the present invention is explained in detail by using accompanied drawings.

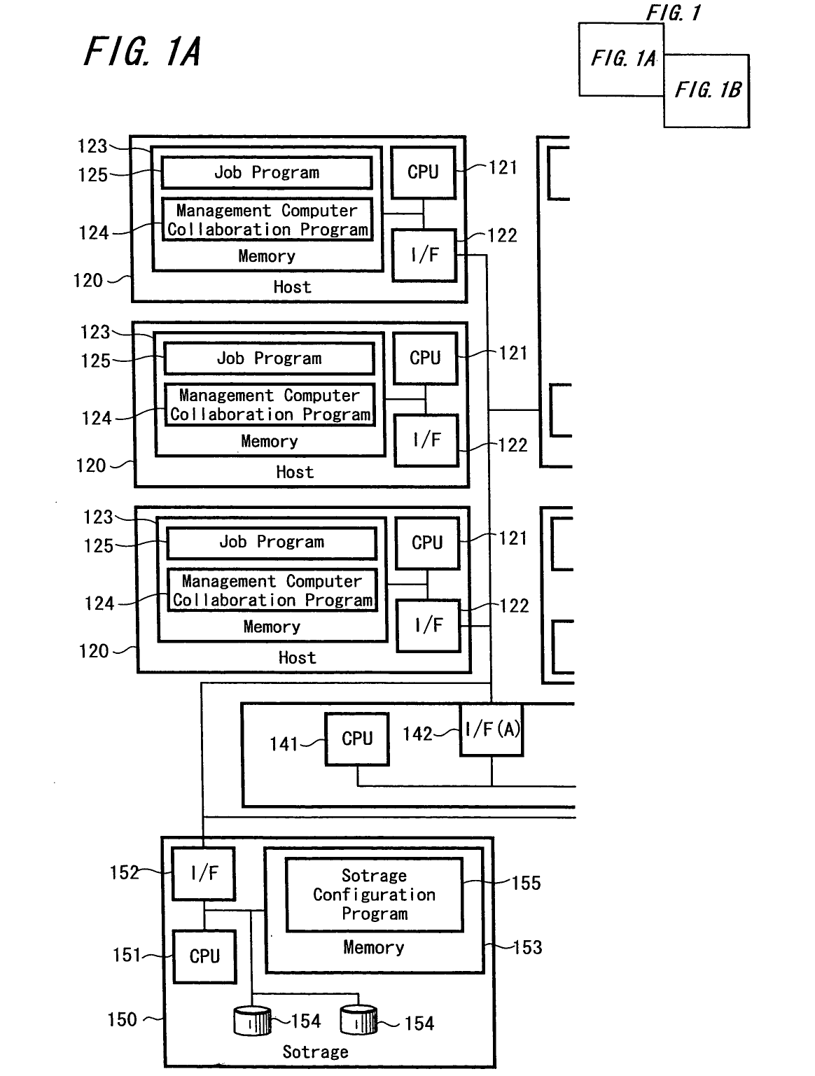

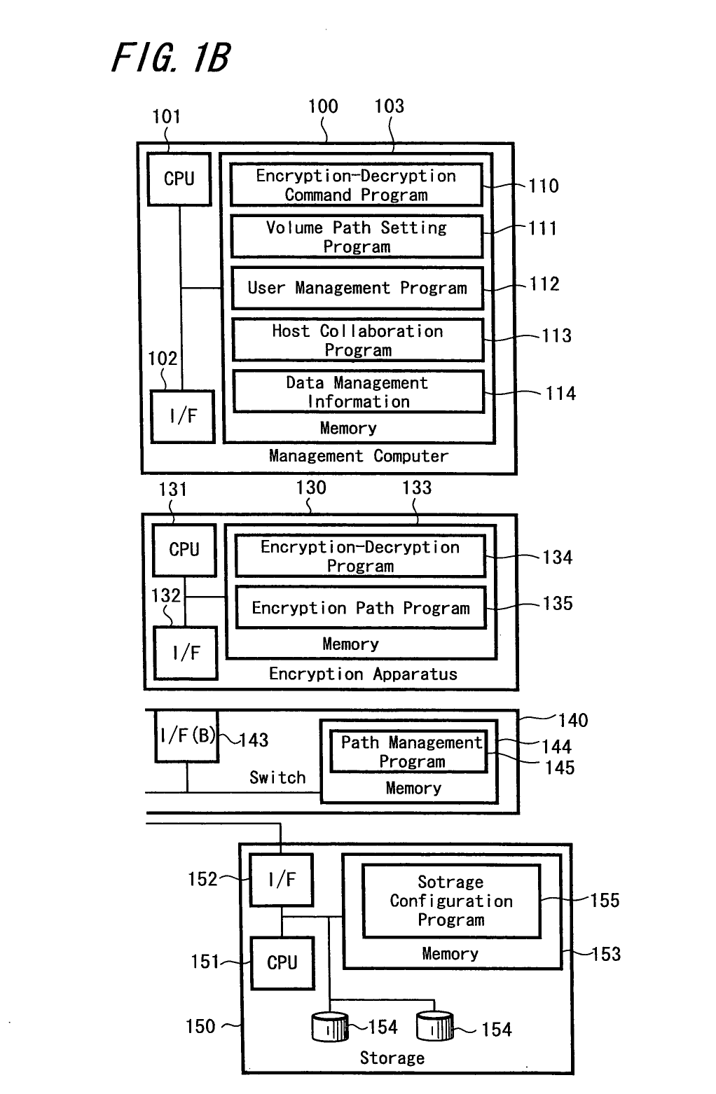

FIGS. 1A and 1B are one example of diagrams showing a configuration of a data management system according to a first embodiment of the present invention.

A storage 150 is comprised of a volume 154 which is a management area for storing data to be actually operated by a computer (for example, a host 120), an I/F 152 which performs transmission and reception of a data I/O related to reading and writing of the volume 154 and which performs communication with a management computer 100 or the like, a CPU 151 which actually controls the storage, and a memory 153. As for the I/F 152, when communication forms differ (for example, the communication with the management computer is the IP (Internet Protocol), the data I/O is the FC (Fibre Channel) and the like), a communication apparatus may be separately arranged for every communication form depending on the communication form. There is a storage configuration program 155 in the memory 153, and it is executed by the CPU 151. The storage configuration program 155 is a program which manages a configuration of the volume of the storage 150, and it has functions of the storage such as a function which creates a plurality of replication volumes to a certain volume by using the volume 154, a function to have the host 120 recognize the volume through the I/F 152 (hereinafter, also referred to as a path setting function) and a function to limit the host which is made to recognize after using this path setting function. Moreover, the volume 154 may be a hard disk or a logical volume which is a RAID composition of hard disks, or there may be a case where it exists as a removable medium such as a tape or a DVD in order to take backup of data in a backup system or the like. Also in this case, the storage 150 may be a medium made of the hard disk, or it may be an apparatus which has a plurality of hard disks and realizes a volume of the RAID composition, or it may be a tape library which is an apparatus replacing automatically the tape of the removable medium, or it may be a DVD library which is an apparatus replacing the DVD automatically.

The management computer 100 is comprised of a CPU 101, a memory 103 and an I/F 102 which performs communication with the storage 150 or the host 120. An encryption-decryption command program 110, a volume path setting program 111, a user management program 112 and a host collaboration program 113 are the ones to realize processing of the embodiment of the present invention. The encryption-decryption command program 110, the volume path setting program 111, the user management program 112 and the host collaboration program 113 are stored in the memory 103 of the management computer 100, and they are executed by the CPU 101. Data management information 114 is information used by the encryption-decryption command program 110, the volume path setting program 111, the user management program 112 and the host collaboration program 113.

The host 120 is a computer which transmits and receives the data I/O to/from the volume 154 of the storage 150 through an I/F 122 so as to store and edit the data of the host in the volume 154. The host 120 is comprised of the above stated I/F 122, a CPU 121 and a memory 123. When information of the host 120 is managed by the management computer 100, the information is transmitted to the management computer 100 through the I/F 122 by using a management computer collaboration program 124 on the memory 123 of the host 120. Moreover, a job program 125 of the host 120 is a program which performs a job which is operated on the host 120. As this job (application), there are data management which creates and updates the data on the volume 154, backup management which performs replication of the data and the like. The management computer collaboration program 124 and the job program 125 which are stored in the memory 123 are executed by the CPU 121. The I/F 122 is connected with both the management computer 100 and the storage 150, but when a protocol such as TCP/IP is used for the transmission and reception of the information to/from the management computer 100 and a protocol such as the Fibre Channel is used to/from the storage 150, in other words when separate protocols are used for the connections, the I/F 122 may be separate I/Fs respectively. To put it another way, when both the management computer 100 and the storage 150 use the same protocol for the transmission and reception of the data of the host 120, for example, the I/F 122 may be comprised of one I/F apparatus.

An encryption apparatus 130 is an apparatus which has a function to encrypt the volume data for data protection to the data of the volume 154 of the storage 150 which is used by the host 120. The encryption apparatus 130 is comprised of an I/F 132, a CPU 131 and a memory 133, and the CPU 131 which performs actual processing of the encryption apparatus performs the transmission and reception of the data to/from the host 120 and the storage 150 through the I/F 132. In order to perform the encryption and decryption of the volume in the encryption apparatus 130, an encryption-decryption program 134 is used on the memory 133 of the encryption apparatus 130. Moreover, the data to be encrypted is decided by an encryption path program 135 which determines a path to transmit the data after the encryption and a path to transmit and receive the data after the decryption, and the path to transmit and receive the volume data to/from each apparatus (storage 150, host 120) is registered. The encryption-decryption program 134 and the encryption path program 135 on the memory 133 are executed by the CPU 131. The I/F 132 of the encryption apparatus 130 is connected with a switch 140, and the transmission and reception of the data is to be perform to/from the management computer 100, the host 120 and the storage 150 through this switch 140. When the protocol such as the TCP/IP is used for the transmission and reception of the information to/from the management computer 100 and the protocol such as the Fibre Channel is used to/from the storage 150 and the host 120, in other words when the separate protocols are used for the connections, the I/F may be made to be separate I/Fs respectively. Herein, the CPU 131 of the encryption apparatus 130 performs the transmission and reception of the data to/from the storage 150 and the host 120 through the switch 140 by using the Fibre Channel, and an I/F for the TCP/IP is provided separately for performing the communication with the management computer 100. In addition, it is also possible to provide with an environment in which the transmission and reception can be performed directly to/from the management computer 100. The encryption apparatus 130 may exist in the storage 150 or it may exist in the host 120. Alternatively, it may also exist in the switch 140. When volumes of a plurality of storages are managed by common encryption among a plurality of hosts, a plurality of encryption apparatuses become necessary, and therefore it is necessary that the encryption apparatuses in the host 120 or in the storage 150 are made to be able to perform the encryption and decryption in common.

The switch 140 is an apparatus which adjusts a destination of the transmission and reception of the data of the management computer 100, the host 120, the encryption apparatus 130 and the storage 150. Data communication with the management computer 100, the host 120 and the storage 150 is performed through an I/F (A) 142 and data communication with the encryption apparatus is performed through an I/F (B) 143. This switch 140 is comprised of a CPU 141 which performs actual processing of the switch and a memory 144. As a program to adjust the destination of the transmission and reception of the data in the switch 140, there is a path management program 145 on the memory 144. A path which can perform the transmission and reception of the data through the switch is determined and operated by this path management program 145. The path management program 145 on the memory 144 is executed by the CPU 141. Moreover, the switch 140 is provided with the path I/F (A) 142 and I/F (B) 143, and the transmission and reception of the data is performed through those I/Fs among the management computer 100, the host 120, the encryption apparatus 130 and the storage 150. At this time, there may be a case in which the protocol such as the TCP/IP is used for the transmission and reception of the information to/from the management computer 100 and the protocol such as the Fibre Channel is used for the transmission and reception of the information to/from the storage 150, the host 120 and the encryption apparatus 130. Thus, when the connection is performed by using a separate protocol depending on an object of the transmission and reception, the path I/F (A) 142 and I/F (B) 143 may be I/Fs which are exclusive for the separate protocols respectively. In other words, it is also possible that the protocol such as the Fibre Channel is used for the transmission and reception of the data to/from the storage 150, the host 120 and the encryption apparatus 130 and that the I/F for the TCP/IP is proved separately for the communication with the management computer so as to provide with the environment where the direct transmission and reception is possible to/from the management computer. Moreover, an apparatus such as a switch which unifies a network becomes necessary in order to connect a plurality of apparatuses such as a storage and a host on the network, but in the present embodiment, it is confined for the convenience of simplification to showing demonstratively that the switch is used in order to connect the encryption apparatus and other devices, and also no specific reference is made to a connection method of the switch 140 when there exist a plurality of actual hosts 120. Herein, the encryption apparatus 130 is not necessarily provided independently but it is also possible to comprise so as to have it in either of the host 120 or the storage 150, or so as to have it on the path between the host 120 and the storage 150, for example.

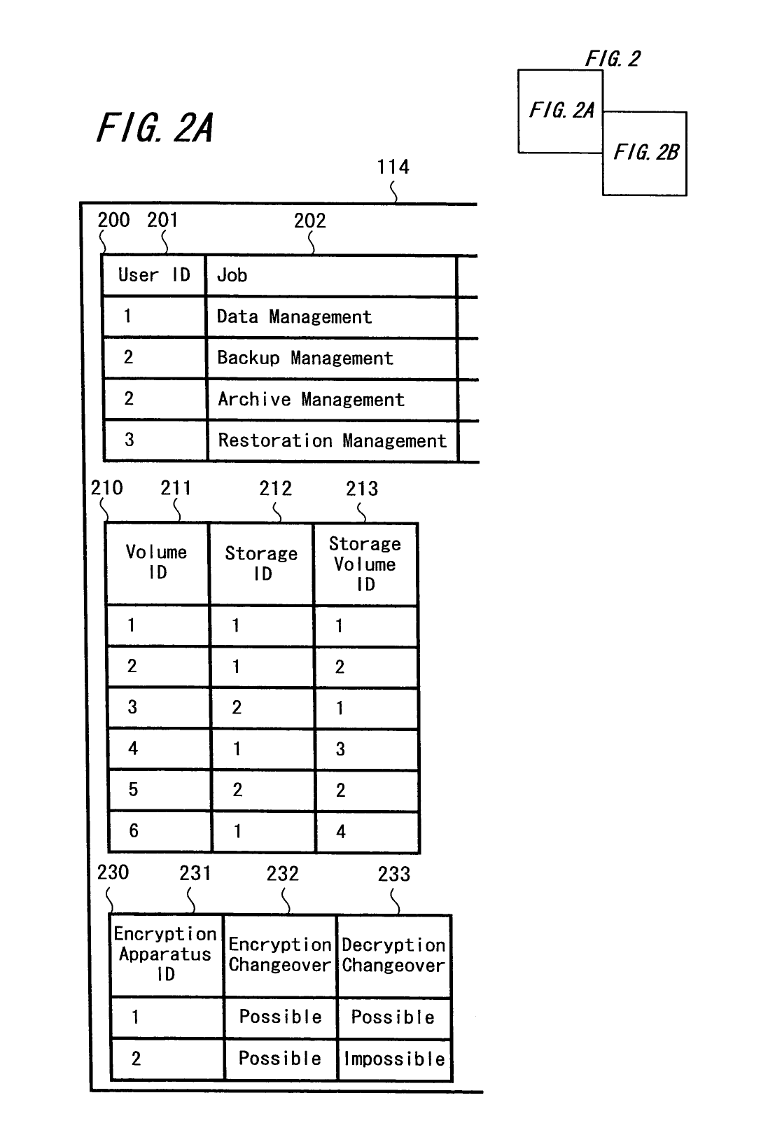

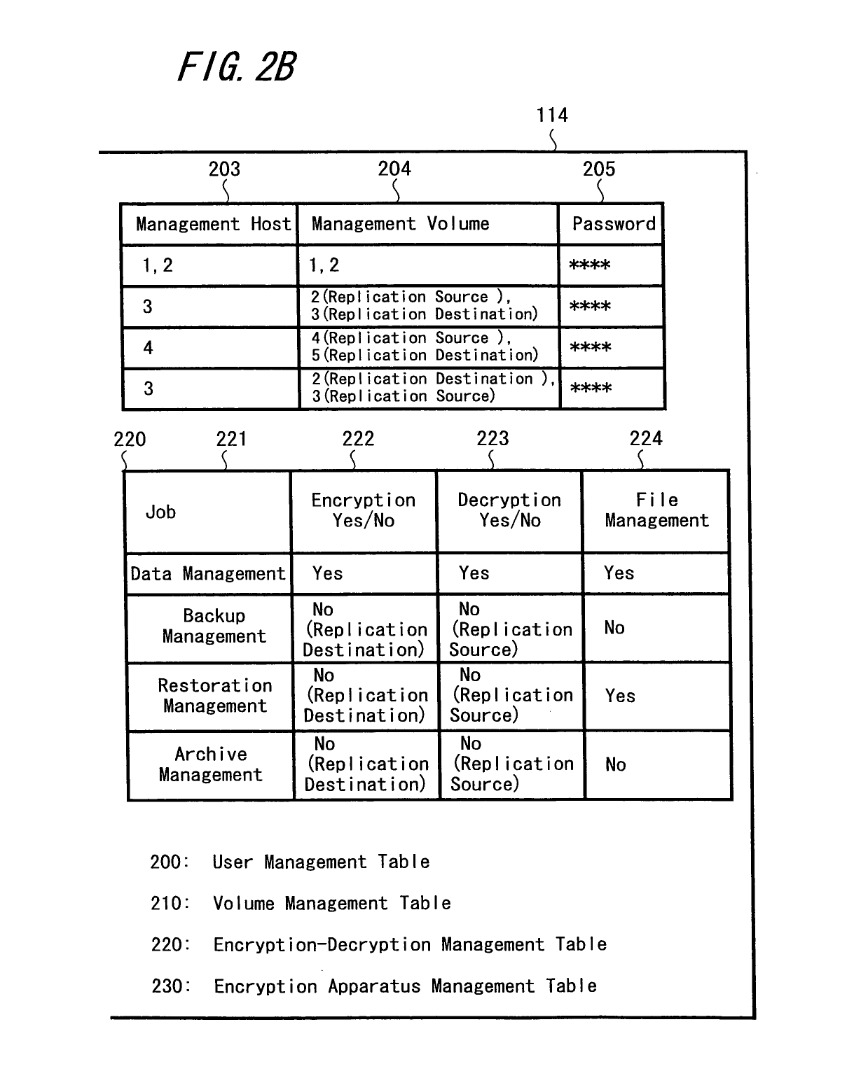

FIGS. 2A and 2B are one example of diagrams explaining a table group of the data management information 114 to be used in each program which is executed by the management computer 100 in a first embodiment of the present invention. The table group shown in FIGS. 2A and 2B are the one which is stored beforehand in the management computer 100 at the time of building a system.

As the data management information 114, there are a user management table 200, a volume management table 210, an encryption-decryption management table 220 and an encryption apparatus management table 230.

Information on a user ID 201 for identifying each administrator, a job 202 showing an management job (application) of each user, a management host 203 showing a host which is used by each user, a management volume 204 showing a volume which is managed by each user and a password 205 of each user in the embodiment of the present invention is stored in the user management table 200. The management host shows an identifier of the host 120 and the management volume shows an identifier of the volume 154.

For example, according to an example of the user management table 200, it is shown in a user ID 1 that the management job is data management; hosts to manage are ID 1 and 2; and volumes to manage are 1 and 2.

Moreover, in the management volume herein, when the job is backup management for example, there are descriptions of “replication destination” and “replication source” in the management volume, and this describes a usage of the management volume in each job. In the backup management, it is shown that a volume of a management volume 2 is a replication source for replicating a volume and a volume of a management volume 3 is a replication destination. In other words, it shows that backup of data on the management volume 2 is taken on the volume of the management volume 3. Also in archive management, it shows that archive is taken on a management volume 5 from a management volume 4. Moreover, also in restoration management, it shows that restoration is taken on the management volume 2 from the management volume 3.

A volume ID 211 which identifies a volume, a storage ID 212 which identifies a storage and a storage volume ID 213 which identifies a volume inside each storage are stored in the volume management table 210. When a plurality of storages are managed by the management computer 100, this table is used in order to identify volumes of the plurality of storages. A Value shown in the management volume 204 of the user management table 200 is equivalent to a value of the volume ID 211 of the volume management table 210.

Information on a job 221 which shows the management job, encryption yes/no 222 which shows whether the volume of the storage is encrypted in each job shown in the job 221, decryption yes/no 223 which shows whether the encrypted volume of the storage is decrypted and passed to the host in each job shown in the job 221 and a file management 224 which shows whether the data is managed per unit of file not per unit of volume has been stored in the encryption-decryption management table 220. Moreover, in the encryption yes/no 222 and the decryption yes/no 223, there are descriptions of “replication destination” and “replication source”, and the description of “replication destination” shows that yes/no of the encryption is checked only to a volume of the replication destination in the job which takes the replication (the backup management, the restoration management and the archive management) and the description of “replication source” shows that yes/no of the decryption is checked only to a volume of the replication source.

For example, in the data management shown in the job 221, the table shows that it is such management that the volume of the storage is encrypted and also it is decrypted at the time of operation by the host.

Moreover, in the backup management, it shows that the volume of the replication source is passed to the host as is basis without performing the decryption in the volume of the storage. Further, it shows that the data is replicated in the replication destination without performing an encryption operation to the volume of the replication destination, namely it shows that if there is a volume encrypted in the storage, the data is reflected to the replication destination directly as is the encrypted volume without performing the decryption.

Moreover, in the restoration management, it shows that when an operation is performed by the host in the volume of the storage, the data of the replication source, which means the data to restore, is not passed as is encrypted per unit of volume but it is passed so as to encrypt per unit of file since the file management is performed. In other words, if there is a volume which is encrypted in the storage, one which is encrypted per unit of file but not per unit of volume is to be passed to the host. However, if processing of performing the restoration per unit of volume is expressly performed, the processing may be performed disregarding the encryption per unit of file so as to pass the encrypted data as is basis without performing the decryption to the data of the volume of the replication source and also without performing the encryption to the volume of the replication destination even if the file management is to be performed, and it is also possible to manage separately the job of volume restoration management and the job of file restoration management.

Moreover, in the job 221, besides those mentioned, there are a job (migration job) which migrates data and a job which moves data in order to improve the performance by making an optimal arrangement of a volume depending on a usage status of the volume. Even in those cases of job, it is not necessary to grant an authority to perform a reference operation to contents of the data inside the volume, and therefore when it accompanies with the movement of the data, similarly to the backup management, the volume data is moved to the replication destination as is basis without performing the decryption to the volume of the replication source in the volume of the storage.

Information on an encryption apparatus ID 231 which identifies an encryption apparatus managed by the management computer, an encryption changeover 232 which shows whether each encryption apparatus can change over the encryption depending on a path and a decryption changeover 233 which shows whether each encryption apparatus can change over the decryption depending on the path are stored in the encryption apparatus management table 230. It is shown by the information of this table that the changeover of either performing the decryption or not performing the decryption is possible depending on the path by putting through each encryption apparatus, if there is one to which the decryption changeover is possible according to the information of the decryption changeover 233. For example, it means that it is possible to show to a certain host information of the volume after performing the decryption but to show to a certain host the information of the volume as is encrypted without performing the decryption. On the contrary, if there is one to which the decryption changeover is not possible, this means that it is made such that one which goes into the encryption apparatus is encrypted at the time of writing in the volume of the storage and is decrypted at the time of reading out of the host, and it is not possible for each host to choose whether or not to perform the decryption.

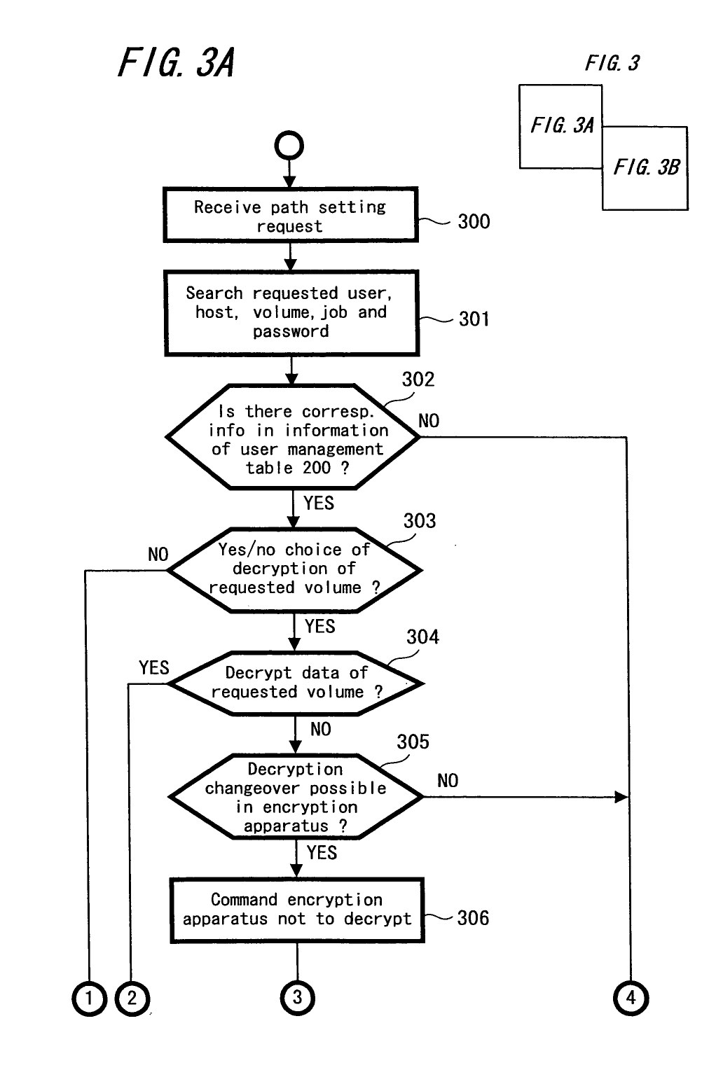

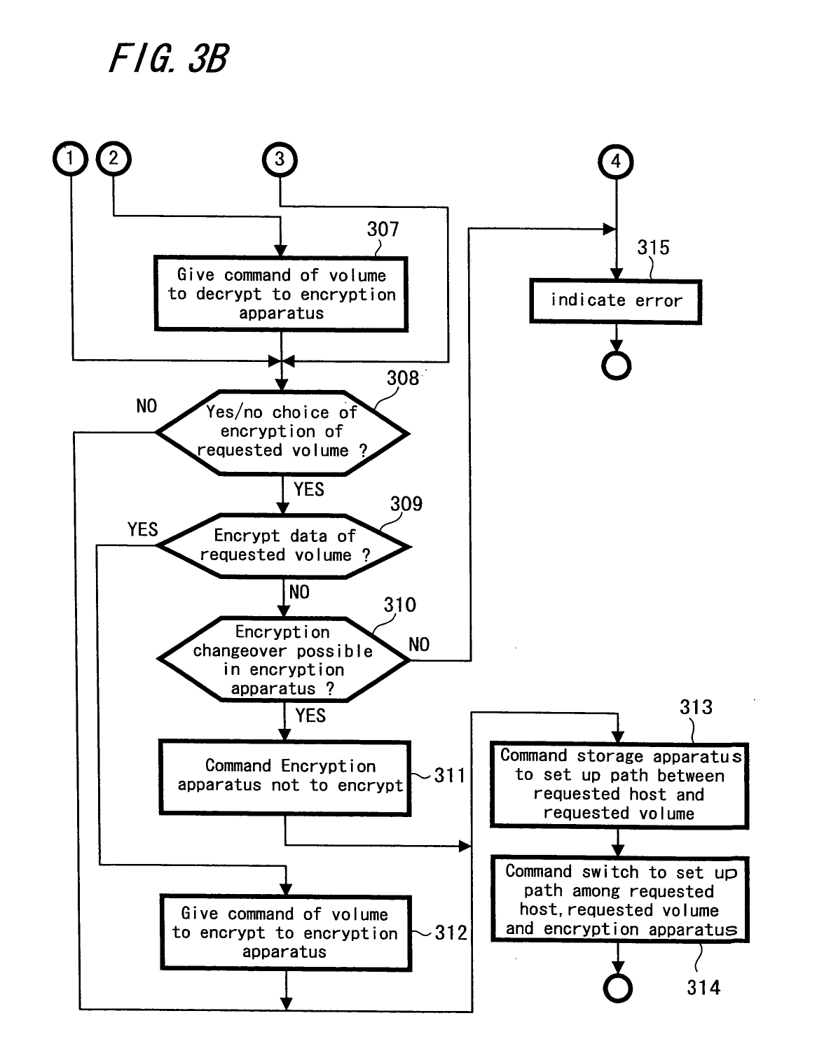

FIGS. 3A and 3B is one example of flow charts showing a procedure of performing the encryption and decryption of a volume on the management computer by a user who uses the volume according to the first embodiment of the present invention. FIGS. 3A and 3B show processing of each portion based on a command which the management computer 100 has transmitted to the host 120, the encryption apparatus 130, the switch 140 and the storage apparatus 150.

The host collaboration program 113 of the management computer 100 receives a path setting request from the management computer collaboration program 124 of the host 120 (Step 300). Values of the user ID, host ID, path setting volume ID and password are received as the request.

Next, based on the request received in step 300, the user management program 112 searches from the user management table 200 whether there is data corresponding to the request (Step 301).

Next, based on a result of the search in step 301, it is judged whether the request which is received by the host collaboration program 113 is correct (Step 302). In other words, it is investigated whether there is the data which coincides with the result of the search in step 301. If the request is correct, it is to proceed to step 303, but if the request is not correct, it is to proceed to step 315 and a message of an error is created to the effect that the request is not correct. Then, this message is returned to the requested host 120 as the error to the request from the host 120 through the host collaboration program 113 and the management computer collaboration program 124, and the processing is ended.

For example, it is supposed that the request received by the host collaboration program 113 is correct. In other words, it is supposed that the request is made to one wherein the user ID is 1, the host ID is 1, the path setting volume ID is 1 and the password is the same as that of the used ID 1. At this time, since there exist the management host 1 and the management volume 1 according to the information of the user ID 1 in the data of the user management table 200, step 301 produces the result of the search as the one which agrees with the request received by the host collaboration program. At this time, step 302 judges that the information received by the host collaboration program is correct one and it is to proceed to step 303.

Moreover, it is supposed that the request received by the host collaboration program 113 is one wherein the user ID is 1, the host ID is 1, the path setting volume ID is 3 and the password is the same as that of the user ID 1, for example. At this time, since there exists the management host 1 but the management volume 3 does not exist according to the information of the user ID 1 in the data of the user management table 200, step 301 produces the result of the search as the one in which the data in the management volume does not agree with the request received by the host collaboration program. At this time, step 302 judges that the information received by the host collaboration program is not correct one and it is to proceed to step 315, and in this case it creates a message to the effect that the value of the volume ID in the path setting request is not correct, and that message is returned to the host which has received the request so as to end the processing.

A job of the user may also be notified in step 300 so as to check in step 302 whether the job of the user coincides with the information of the job in the user management table.

In step 303, it is judged to the requested volume if it is a yes/no choice of whether to decrypt the encrypted volume. In other words, it is judged whether the requested volume is a volume which is an object of the decryption. If it is the one to judge whether or not to decrypt, it is to proceed to step 304, but otherwise it is to proceed to step 308.

For example, when the user of the backup management of the user ID 2 requests a path setup of the management volume 2, it can be noted according to the user management table 200 and the encryption-decryption management table 220 that this is the volume to which yes/no of the decryption is to be checked. In this case, it is to proceed to step 304. However, in case of the management volume ID 3, it is to proceed to step 308 since it is not necessary to check the decryption.

In step 304, it is judged whether the user management program 112 decrypts and has the host 120 recognize the volume of the request which is received by the host collaboration program 113. The job in the requested user ID is acquired from the user ID 201 and the job 202 in the user management table 200 so as to investigate the job corresponding to the user ID, and it is investigated from the decryption yes/no 223 of the encryption-decryption management table 220 whether the job is one which is allowed to decrypt so as to have the host recognize. Then, if the decryption is allowed, it is to proceed to step 307, but if the decryption is not allowed, it is to proceed to step 305.

For example, as for the user of the user ID 1, it can be noted from the user management table 200 that the job is the data management. Further, it can be noted from the encryption-decryption management table 220 that it is shown that the decryption is to be performed in the job of the data management. Therefore, it is judged in this case that the decryption is allowed, and it is to proceed to step 307.

Moreover, when the user of the user ID 2 sends the request, it can be noted from the user management table 200 that the job of the user ID 2 is the backup management. Further, as for the job of the backup management, it is to be judged to the volume ID 2 with respect to checking of the decryption, and it can be noted from the encryption-decryption management table 220 that it is shown that the decryption is not performed to this volume. Therefore, it is judged in this case that the decryption is not allowed, and it is to proceed to step 305.

In step 305, the encryption-decryption command program 110 judges whether the decryption changeover per volume is possible in the encryption apparatus which is available for use. If the decryption changeover is possible, it is to proceed to step 306, but otherwise it is to proceed to step 315, a message to the effect that it is not possible to have the host recognize without performing the decryption is created as an error message, and that message is to be returned to the request source.

For example, it is investigated from the encryption apparatus management table 230 whether the decryption changeover is possible in the encryption apparatus which is used. If the encryption apparatus ID 1 is used, it can be noted that the decryption changeover is possible. At this time, it is deemed that the decryption changeover is possible, and it is to proceed to step 306.

Moreover, when it is registered in the management computer that only the encryption apparatus ID 2 can be used as the encryption apparatus, it can be noted that the encryption apparatus can not perform the decryption changeover. At this time, it is to proceed to step 315 as it is deemed that the decryption changeover is not possible, and the error message is to be returned to the request source.

In step 306, when the host is made to recognize the volume data through the encryption apparatus between the host and volume which the user has requested, the encryption-decryption command program 110 commands the encryption path program 135 of the encryption apparatus 130 not to perform the decryption. Then, it is to proceed to step 308.

For example, when the host collaboration program 113 receives the request of the user ID 2 and when the request of requesting host ID3 and volume ID 2 comes in, it can be noted that the processing up to step 305 is overlapped; it is judged that the host is made to recognize without performing the decryption; and the encryption-decryption command program 110 requests that the encryption path program 135 of the encryption apparatus 130 makes the host recognize without performing the decryption. When the host of the host ID 3 makes access to the data of the volume of the volume ID 2 via a route of the host ID 3 and the volume ID 2, the encryption path program 135 which has received the command is to have the host recognize the volume data as is encrypted without performing the decryption.

In step 307, when the host is made to recognize the volume data through the encryption apparatus between the host and volume which the user has requested, the encryption-decryption program 110 commands the encryption path program 135 of the encryption apparatus 130 to perform the decryption.

Also in step 307, when encryption forms of the encryption apparatus ID 1 and the encryption apparatus ID 2 are different according to the encryption apparatus management table 230, it is necessary to specify the same encryption apparatus as the one which is used at the time of encryption. In this case, when the data is encrypted and saved in the volume management table 210, the attribute of “encryption apparatus ID” may be provided so as to keep information on the encryption apparatus registered. Moreover, it is also possible that the encryption form of the encryption apparatus is provided in the encryption apparatus management table 230 such that the command can be given to the encryption path program 135 of the encryption apparatus having the same encryption form at the time of decrypting the data.

In step 308, it is judged to the requested volume if it is a yes/no choice of whether to encrypt the volume. In other words, it is judged whether the requested volume is a volume which is an object of performing the encryption. If it is to judge whether to encrypt, it is to proceed to step 309, but otherwise it is to proceed to step 313.

For example, when the user of the backup management of the user ID 2 requests the path setup of the management volume 3, this is the replication destination according to the user management table 200 and the encryption-decryption management table 220, and therefore it can be noted that it is the volume to which yes/no of the encryption is to be checked. In this case, it is to proceed to step 309. However, in case of the management volume 2, it is not necessary to check the encryption since it is the replication source, and therefore it is to proceed to step 313.

In step 309, it is judged whether the user management program 112 performs the encryption and has the host 120 recognize the volume of the request which is received by the host collaboration program 113. The job in the requested user ID is acquired from the user ID 201 and job 202 of the user management table 200, the job corresponding to the user ID is investigated, and it is investigated from the encryption yes/no 222 of the encryption-decryption management table 220 whether that job is allowed to encrypt and have the host recognize. Then, if the encryption is allowed, it is to proceed to step 312, but if the encryption is not allowed, it is to proceed to step 310.

For example, it can be noted from the user management table 200 that the job is the data management in case of the user of the user ID 1. Further, it can be noted from the encryption-decryption management table 220 that it is shown that the encryption is performed in the job of the data management. Therefore, it is judged in this case that the encryption is allowed and it is to proceed to step 312.

Moreover, when the user of the user ID 2 sends a request, it can be noted from the user management table 200 that the job of the user ID 2 is the backup management. Further, as for the job of the backup management, it is judged to the volume ID 3 of replication destination volume with respect to the checking of the decryption, and it can be noted from the encryption-decryption management table 220 that it is shown that the encryption is not performed in the job of the backup management. Therefore, it is judged in this case that the encryption is not allowed, and it is to proceed to step 310.

In step 310, the encryption-decryption command program 110 judges whether the encryption changeover per volume is possible in the encryption apparatus which is available for use. If the encryption changeover is possible, it is to proceed to step 311, but otherwise it is to proceed to step 315, a message to the effect that it is not possible to have the host recognize without performing the encryption is created as the error message, and that message is to be returned to the request source.

For example, it is investigated from the encryption apparatus management table 230 whether the encryption changeover is possible in the encryption apparatus which is used. It is understood that the encryption changeover is possible in both the encryption apparatuses ID 1 and ID 2. At this time, it is deemed that the encryption changeover is possible, and it is to proceed to step 311.

However, when only the encryption apparatus in which the encryption changeover is not possible is registered, it is to proceed to step 315 and the error message is to be returned to the request source.

In step 311, when the host is made to recognize the volume data through the encryption apparatus between the host and volume which the user has requested, the encryption-decryption command program 110 commands the encryption path program 135 of the encryption apparatus 130 not to perform the encryption. Then, it is to proceed to step 313.

For example, when the host collaboration program 113 receives the request of the user ID 2 and when the request of requesting the host ID 3 and the volume ID 3 comes in, it can be noted that the processing up to step 310 is overlapped; it is judged that the host is made to recognize without performing the encryption; and the encryption-decryption command program 110 requests the encryption path program 135 of the encryption apparatus 130 to have the host recognize without performing the encryption. When the host of the host ID 3 makes access to the data of the volume of the volume ID 3 via a route of the host ID 3 and the volume ID 3, the encryption path program 135 which has received the command is to have the host perform the operation as is encrypted in the replication source without further performing the encryption of the volume data to the replication destination.

In step 312, when the host is made to recognize the volume data through the encryption apparatus between the host and volume which the user has requested, the encryption-decryption command program 110 commands the encryption path program 135 of the encryption apparatus 130 to perform the encryption.

In step 312, when the encryption forms of the encryption apparatus ID 1 and the encryption apparatus ID 2 are also different according to the encryption management table 230, it is necessary to specify the same encryption apparatus as the one which is used at the time of encryption. In this case, when the data is encrypted and saved in the volume management table 210, the attribute of “encryption apparatus ID” may be provided so as to keep information on the encryption apparatus registered. Moreover, it is also possible that the encryption form of the encryption apparatus is provided in the encryption apparatus management table 230 such that a command can be given to the encryption path program 135 of the encryption apparatus having the same encryption form at the time of encrypting the data.

In step 313, the volume path setting program 111 commands the storage configuration program 155 of the storage 150 to set up a path between the requested host and the requested volume.

In step 314, the volume path setting program 111 commands the path management program 145 of the switch 140 to set up a path among the requested host, the requested volume and the encryption apparatus. Then, the path setup between the requested host and the requested volume is realized and the processing is ended.

In step 315, as the process has become the error, the error message is made to the effect that it has become the error, and an error notification is to be made by returning that message to the request source, or the like.

By performing the above mentioned processing, it is judged whether to perform the decryption of the volume according to the user's request, the setup of the encryption apparatus is decided according to the job, and it becomes possible to set up the path from the host to the storage.

Then, the job program 125 of the host 120 recognizes the volume of the encrypted data and the decrypted volume according to the job and it is to perform an actual job. For example, in case of the host for the backup management, the host is made to recognize the encrypted volume of the replication source as is basis (for example, made to recognize as a raw device), and when contents of that volume are replicated on the replication destination, they are replicated without encrypting the data, namely, as is the encrypted data of the replication source. Thereby, the user who performs the backup management can perform the operation of the backup even if the contents of the volume are not known due to a reason of being encrypted.

Thereby, the path is set according to the user's job, and in case of the job of the data management, for example, the volume data is encrypted to each volume and the decrypted one is acquired when it is recognized by the host. Moreover, since the volume data is encrypted in the backup management, it becomes possible that the host recognizes the volume data of the replication source as is the encrypted data without performing the decryption even when the host recognizes it (the Volume ID 2 of the user management table 200) and the data is written into another volume for backup, that is the volume of the replication destination (the volume ID3 of the user management table 200), without performing the decryption.

Moreover, the processing has been separated per each user in the first embodiment of the present invention, but if a server and a job have one-to-one correspondence irrespective of a user, the processing of the encryption and decryption may be decided according to the correspondence of the server and the job when a request comes from a certain server.

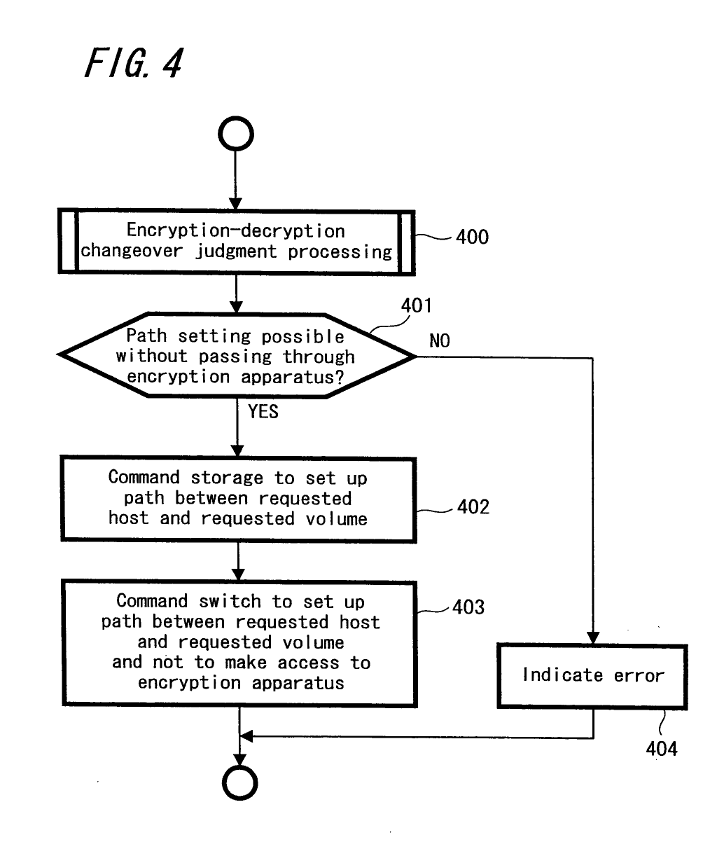

FIG. 4 is another example of a flow chart showing a procedure of performing the encryption and decryption of a volume by a user who uses the volume on the management computer as the first embodiment of the present invention. FIG. 4 shows processing of each portion based on a command which the management computer 100 has transmitted to the host 120, the encryption apparatus 130, the switch 140 and the storage apparatus 150.

In step 400, processing herein is either up to the processing wherein the processing up to step 305 shown in FIG. 3A is performed and it is judged in the processing of 305 that the encryption apparatus can not perform the changeover of the decryption or up to the processing wherein the processing up to step 310 is performed and it is judged in the processing of 310 that the encryption apparatus can not perform the changeover of the encryption. Both the processing of step 305 and the processing of step 310 proceed to step 315 and become errors so as to end the processing in case of the processing explained in FIGS. 3A and 3B, but in the flow chart of FIG. 4, processing of carrying out the decryption changeover or the encryption changeover is performed by another operation instead of step 315.

In step 401, it is judged whether a path is set without passing through the encryption apparatus. This judgment is to judge whether it is possible to realize an environment of not encrypting or not decrypting by setting the path even when the encryption apparatus is not able to perform the changeover, in other words it is to judge whether the requested host and the requested volume can set the path without passing through the encryption apparatus. If it is possible to set the path, it is to proceed to step 402, but if it is not possible to set the path, it is to proceed to step 404 and an error is issued so as to end.

For example, if it is not possible to set the path without passing through the encryption apparatus when the switch 140 is connected with the encryption apparatus, it is to proceed to step 404 as an error and the error is outputted so as to end the processing.

In step 402, the volume path setting program 111 commands the storage configuration program 155 of the storage 150 to set the path to the requested host and the requested volume.

In step 403, the volume path setting program 111 commands the path management program 145 of the switch 140 to set the path to the requested host and the requested volume so as to realize the path between the host and the volume without extending the path to the encryption apparatus and without passing through the encryption apparatus. Then, the path setting between the requested host and the requested volume is realized and the processing is ended.

In step 404, the error is outputted in accordance with an error status of step 401.

By performing the above mentioned processing, It is judged whether the decryption of the volume is performed in accordance with the user's request and it becomes possible to set up the path from the host to the storage with adjusting the decryption changeover and the encryption changeover according to the job even without passing though the encryption apparatus.

When the processing proceeds to step 305 in the processing of step 400, the processing of step 401 or step 402 may be performed without performing the processing of step 305. In other words, irrespectively of whether to request to the encryption apparatus, the decryption changeover may be realized only by setting up a path route from the beginning.

Moreover, when the processing proceeds to step 310 in the processing of step 400, the processing of step 401 or step 402 may be performed without performing the processing of step 310. In other words, irrespectively of whether to request to the encryption apparatus, the encryption changeover may be realized only by setting up the path route from the beginning.

Moreover, it is also possible to have the user choose whether to perform the decryption changeover by the encryption apparatus or whether to realize the decryption changeover only by setting up the path.

Moreover, it is also possible to have the user choose whether to perform the encryption changeover by the encryption apparatus or whether to realize the encryption changeover only by setting up the path.

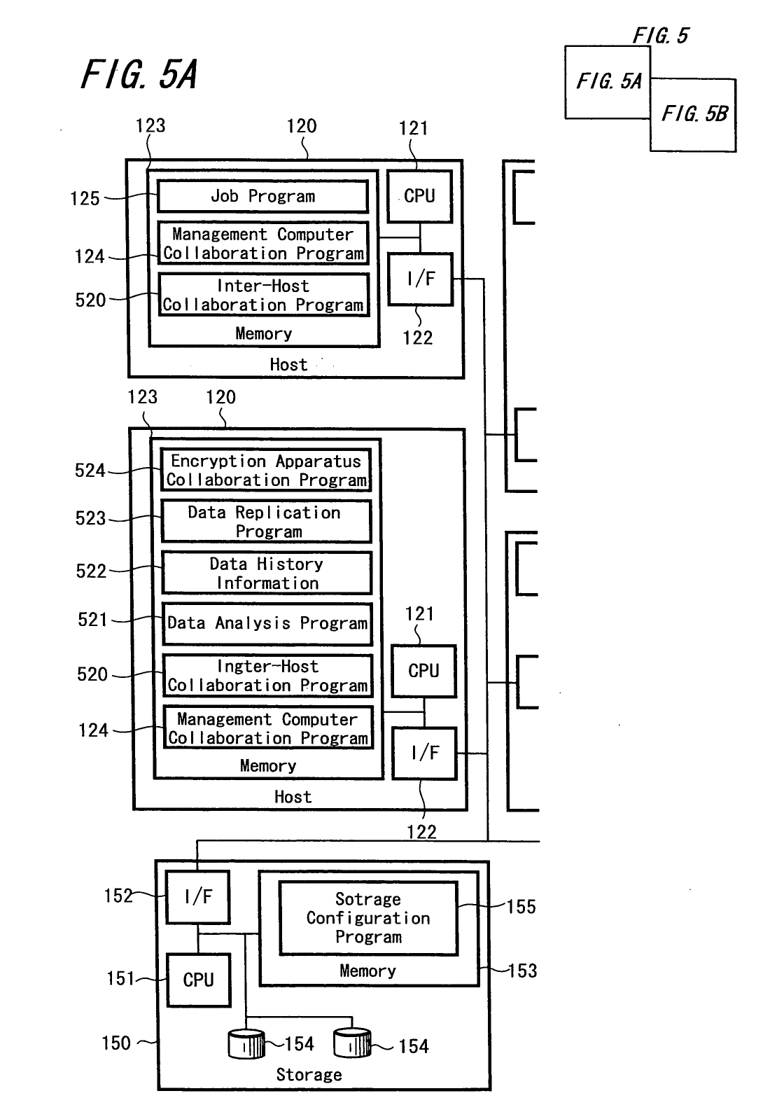

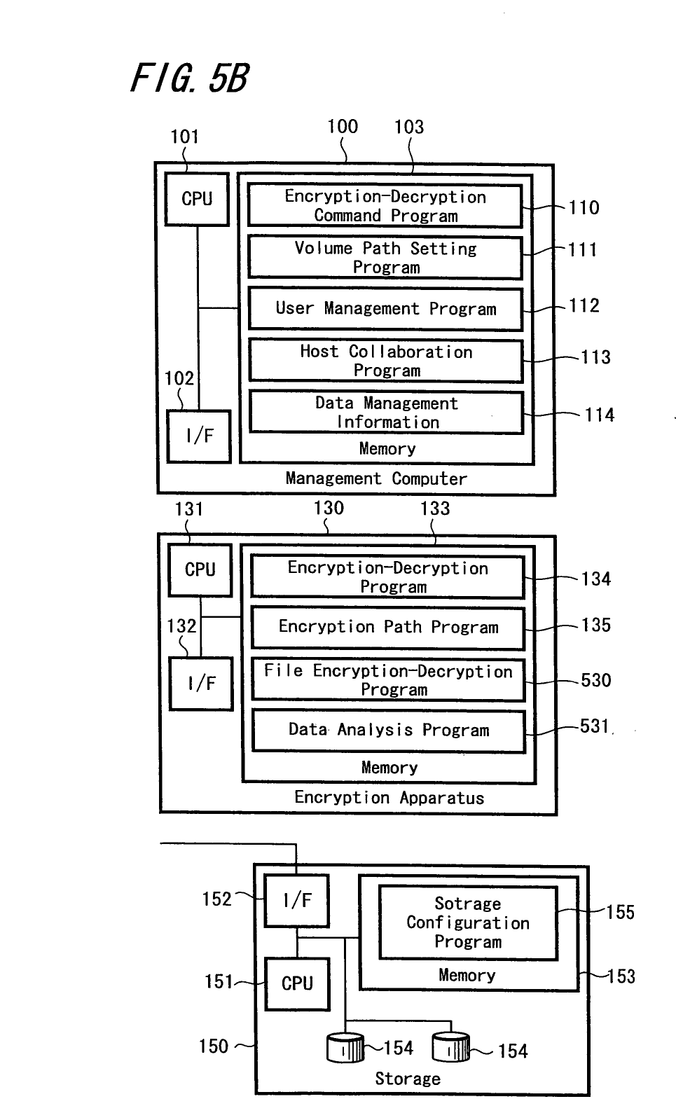

FIGS. 5A and 5B are one example of diagrams showing a configuration of a data management system in a second embodiment of the present invention.

In the host 120, an inter-host collaboration program 520, a data analysis program 521, a data replication program 523 and an encryption apparatus collaboration program 524 exist on the memory 123 in addition to the programs explained in FIG. 1A, and the CPU 121 executes those programs so as to perform processing of the programs. Moreover, data history information 522 which is used by the data replication program 523 and the encryption apparatus collaboration program 524 also exists on the memory 123.

The inter-host collaboration program 520 is a program which exchanges data or requests mutually among hosts, it exists on the memory 123 of the host 120, and it is executed by the CPU 121.

The data analysis program 521 is a program to analyze the data form (example, file) which is managed by the host 120. For example, it is equivalent to a file system which operates in the host 120.

The data history information 522 is an area for saving a history when the host 120 moves or replicates data. For example, when the data is moved from a volume 154 of a storage 150 to a volume 154 of another storage 150, a moving date and hour of the data, a file name of the data and the like are recorded.

The data replication program 523 is a program which replicates data on a volume of a certain storage from a volume of a certain storage. Whether to replicate the data or whether to move the data may be chosen correspondingly to processing of moving the data as well. The data replication program 523 is known as a program used by a backup system such as a backup program. Moreover, it is also one form of the job program 125.

The encryption apparatus collaboration program 524 is a program which receives information transmitted by a file encryption-decryption program 530 of the encryption apparatus 130, and the data history information 522 is to be created and updated based on this information.

In the encryption apparatus 130, the file encryption-decryption program 530 and a data analysis program 531 exist on the memory 133 in addition to the programs explained in FIG. 1B, and the CPU 131 executes those programs such that processing of the programs can be performed.

Although the encryption-decryption program 134 is the one which performs the encryption and decryption per unit of volume, the file encryption-decryption program 530 is a program which performs the encryption and decryption per unit of file. The file encryption-decryption program 530 is a program which recognizes data per unit of file from volume data using the data analysis program 531 in order to recognize the data of the file and which performs the encryption and decryption of the file for each of this file.

The data analysis program 531 performs processing which is equivalent to that of the data analysis program of the host 120. In other words, when the data information of the host 120 is managed as the file information, for example, the data analysis program 531 is made to be a program which is able to take the information per unit of file as well so as to set such program that can create the data history information 522 of the host 120.

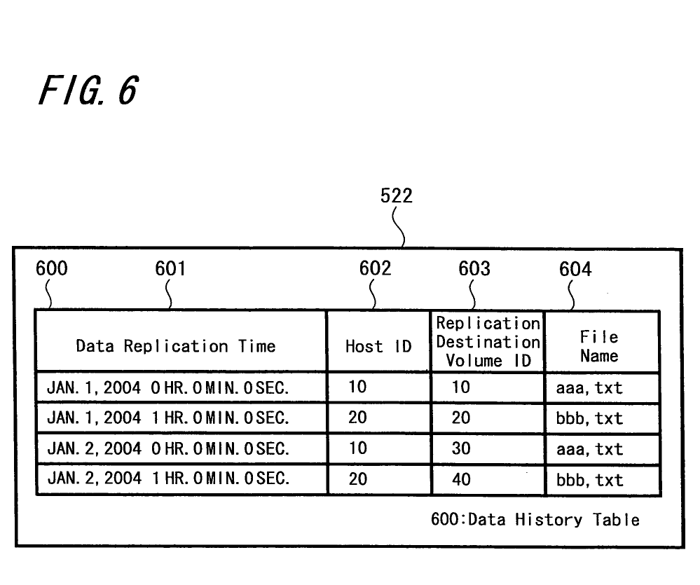

FIG. 6 is one example of a diagram explaining a table of the data history information 522 to be used by the encryption apparatus collaboration program 524 which is executed by the host 120 in the second embodiment of the present invention.

A data history table 600 has a data replication time 601 which is the date and hour of taking a data replication, a host ID 602 of a host having data which becomes a source of the data replication, a replication destination volume ID 603 of a volume at a replication destination and a file name 604 of a replicated file. An actual relation between the replication source volume and the replication destination volume is to be managed by the data replication program 523, and collaboration is to be made such that this information can be also reflected to the data replication program 523.

For example, according to the example of FIG. 6, it means that a file aaa.txt of a host ID 10 is replicated on a replication destination volume ID 10 at the time 0 hour 0 minute on January 1, 2004.

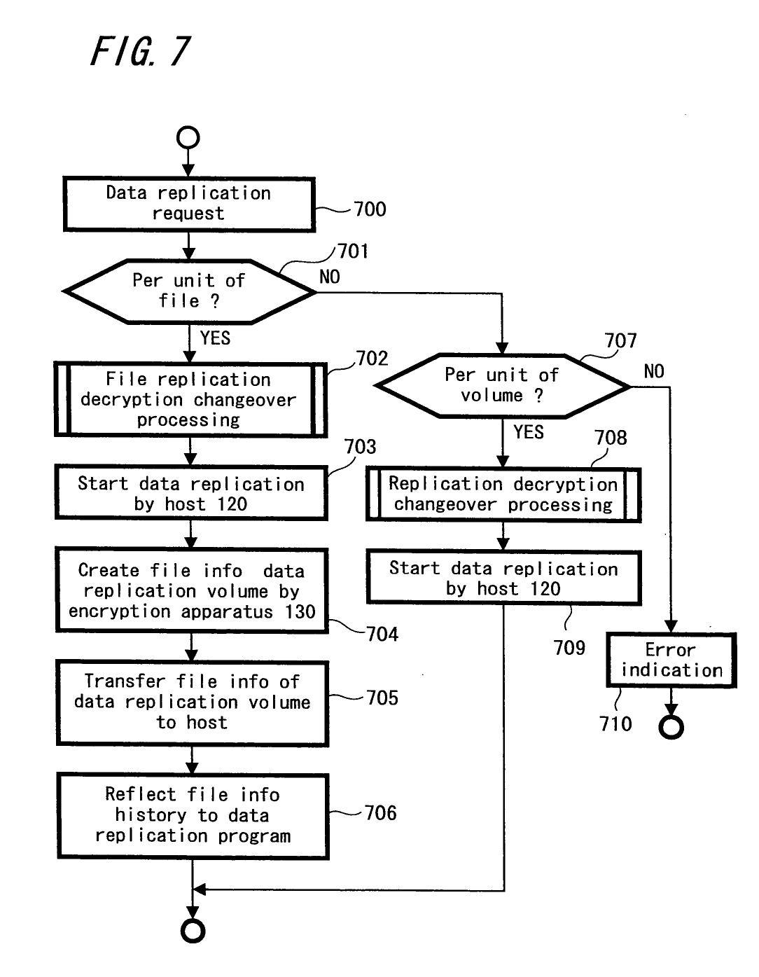

FIG. 7 is one example of a flow chart showing a procedure which is performed by using the encryption apparatus when a replication of a volume is performed on the management computer as the second embodiment of the present invention. FIG. 7 shows processing of each portion based on a command which the management computer 100 has transmitted to the host 120, the encryption apparatus 130 and the storage apparatus 150.

The inter-host collaboration program 520 of the host 120 receives a request from a host 120 which actually performs a data replication (Step 700).

Next, in step 701, it is judged according to the request of step 700 whether a recording unit of the data replication is a unit of file. If it is a unit of file, it is to proceed to step 702, but otherwise it is to proceed to step 707.

File replication decryption changeover processing is performed in step 702. This file replication decryption changeover processing is to perform the processing of the flow chart showing the procedure of performing the encryption and decryption of the volume on the management computer by the user who uses the volume as the first embodiment of the present invention, which is explained in FIGS. 3A and 3B. When the data replication is treated as the backup job, the host which performs the data replication is made to recognize the encrypted volume without decrypting the volume. Further, the management computer 100 gives a command of not performing the decryption to the encryption apparatus 130 and at the same time, when it writes into a data replication destination, a command is given to the data analysis program 531 so as to have the file information memorized.

In step 703, the replication of the volume is actually started, and the data replication program 523 performs processing so as to replicate the data on a volume of a certain storage from a volume of a certain storage. At this time, the data replication program 523 informs the data analysis program 531 of the encryption apparatus 130 through the encryption apparatus collaboration program 524 that the data replication has started and that the data replication is being performed from which replication source volume to which replication destination volume.

In step 704, in the encryption apparatus 130, the file information of the volume to which the data replication is performed by the processing of step 703 is investigated to the objective volume of the replication destination based on the command to the data analysis program 531 in step 702 and the file information is created. It means that it is investigated in the encryption apparatus 130 what file is being replicated presently on the volume of the data replication destination so as to detect a replication destination volume ID and a file name which are the file information in that replication destination volume.

In the processing of step 703 and step 704, the start-up of the data replication and the processing of step 704 need to be synchronized, and therefore it is also possible that the processing of step 704 is activated immediately before the start-up of the data replication and the data replication is started after completing the activation of the processing of step 704.

In step 705, the encryption apparatus 130 transmits the file information which is detected in step 704 to the host 120 which is performing the data replication. Further, in the host 120, it is registered in the data history information 522. In the host 120, the replication destination volume ID 603 and the file name 604 are registered from the information of the encryption apparatus into the data history table 600 which is the information of the data history information 522, and the data replication time 601 which is the time of the data replication on that replication destination volume and the host ID 602 are to be associated and registered.

In step 706, the date replication program 523 checks the file information of the data replication volume based on the data history information 522 and it has that data reflected. At this time, data reference management may be performed such that this data history information 522 can not be recognized by a user whose job is the backup management but can be recognized only by a user whose job is future restoration management. Then, the data replication program 523 checks that the replication has been completed, and the processing is to be ended.

The processing of step 705 and step 706 may be performed after the data replication is completed. In other words, it is possible that the file information is transmitted collectively from the encryption apparatus 130 to the host 120 which performs the data replication and the processing of step 705 and step 706 is performed.

In step 707, it is judged from the data replication request 700 whether the data replication is performed as the volume data. If it is the data replication of the volume, it is to proceed to step 708, but otherwise it is to proceed to step 710 as not performing the data replication neither per unit of file nor per unit of volume, and an error is indicated so as to end the processing.

In step 708, replication decryption changeover processing is performed. The replication decryption changeover processing means to perform the processing of the flow chart showing the procedure of performing the encryption and decryption of the volume on the management computer by the user who uses the volume as the first embodiment of the present invention, which is explained in FIGS. 3A and 3B. When the data replication is treated as the backup job, the host which performs the data replication is made to recognize the encrypted volume without decrypting the volume. Then, it is to proceed to step 709.

In step 709, the host 120 actually starts the data replication by the data replication program 523, and the processing ends after the data replication is completed.

Thereby, it becomes possible to realize a data replication environment according to the user's job even on a file level or on a volume level by using the changeover of the encryption apparatus. Further, it becomes possible to perform the data replication without showing contents of a volume to the user whose job is to perform the data replication.

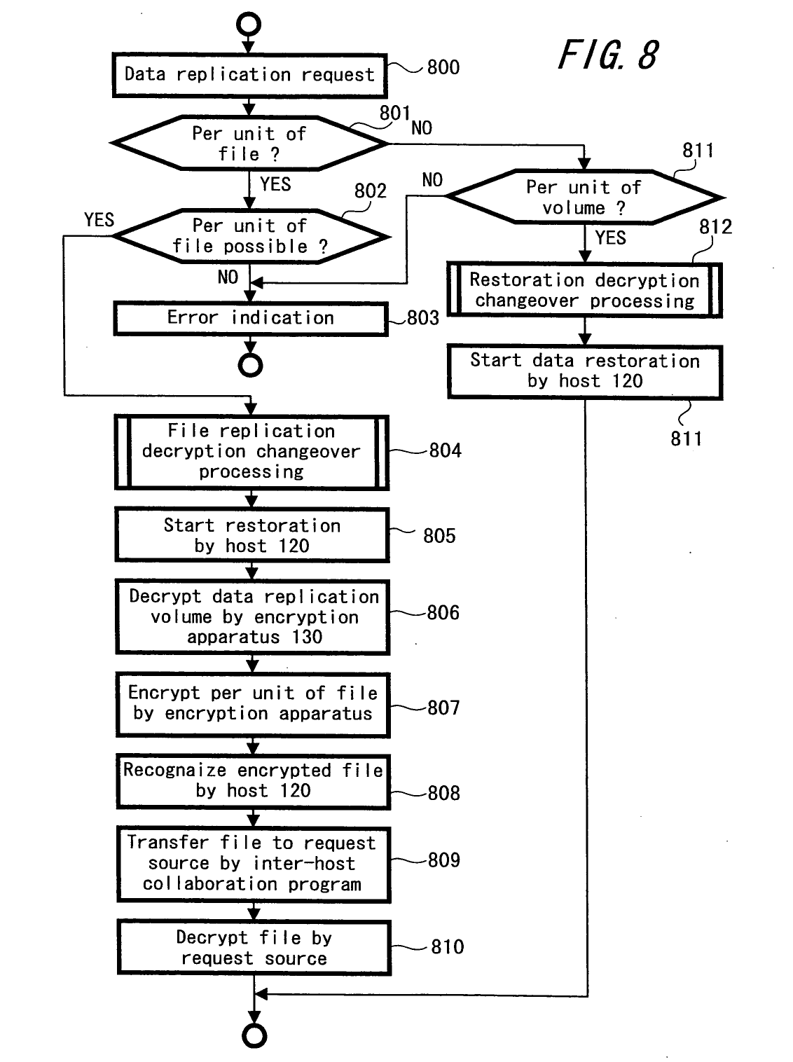

FIG. 8 is one example of a flow chart showing a procedure which is performed on the management computer by using the encryption apparatus as the second embodiment of the present invention when a restoration is performed after a replication of a volume. FIG. 8 shows processing of each portion based on a command which the management computer 100 has transmitted to the host 120, the encryption apparatus 130, the switch 140 and the storage apparatus 150. There are two cases in the restoration after the replication of the volume. One is to detect a portion of data (example, file) out of the data after the replication of the volume, and the other is to return all the data per each volume to the volume of the replication source. One example of a flow chart of a procedure for those two cases is to be explained hereinafter.

Moreover, in the second embodiment of the present invention, there are requisites wherein the processing of the first embodiment of the present invention is performed, the data replication which manages per unit of file is performed in the processing of detecting the above mentioned file, and also the data replication is performed per unit of volume in case of returning all the data per each volume to the volume of the replication source.

The inter-host collaboration program 520 of the host 120 receives a request from the host 120 which actually performs data restoration (Step 800).

Next, in step 801, it is judged according to the request of step 800 whether a unit of performing the data restoration is a unit of file. If it is the unit of file, it is to proceed to step 802, but otherwise it is to proceed to step 811.

In step 802, it is investigated in the encryption apparatus 130 whether the requested file can be restored per unit of file in the data restoration. In other words, it is to determine based on whether the information which is replicated by the data replication program 523 is held per unit of file. If the management computer can restore the requested file on the volume of the replication source, it is to proceed to step 804, but otherwise it is to proceed to step 803 and a message to the effect that the processing has not been performed this time is returned as an error message.

In step 803, the error message to the effect that the processing has not been performed this time is created and returned to the request source so as to end the processing.

The file replication decryption changeover processing is performed in step 804. This file replication decryption changeover processing means to perform the processing of the flow chart showing the procedure of performing the encryption and decryption of the volume on the management computer by the user who uses the volume as the first embodiment of the present invention, which is explained in FIGS. 3A and 3B. When the data restoration is treated as the restoration job, the management computer performs the decryption of the volume but it performs the encryption again per unit of file, and the host which performs the data replication is made to recognize the encrypted volume without performing the decryption up to the file.

In step 805, based on the data history table 600, the restoration of the volume is actually started to the volume in which the requested file to be restored is registered, and the data replication program 523 performs the processing so as to restore the data from the volume of a certain storage.

For example, when it intends to restore the file of aaa.txt at the time 0 hour 0 minute 0 second on January 1, 2004, it is to restore the volume of the replication destination ID 10.

In step 806, the encryption apparatus 130 once decrypts the volume by the encryption-decryption program 131 based on a command of step 804.

In step 807, the encryption is performed per unit of file in the encryption apparatus by the file encryption-decryption program 530 based on the command of step 804. The existence of the file is recognized by the data analysis program 531.

In step 808, the host 120 recognizes the file information which is encrypted by step 807.

In step 809, the same file as the data restoration request is taken out. Then, the taken-out file is transferred to the request source by the inter-host collaboration program 520.

In step 810, the encrypted data is decrypted in the request source and the processing is ended. In order for a data administrator to decrypt, the decryption may be performed also through the encryption apparatus or it is also possible that the request source manages a key for performing the decryption such that the decryption may be performed inside that host.

In step 811, it is judged from the request whether the data restoration is performed as the volume data. If it is the volume restoration, it is to proceed to step 812, but otherwise it is to proceed to step 803 as not performing the restoration neither per unit of file nor per unit of volume, and a message to the effect thereof is returned to the request source as the error message so as to end the processing.

In step 812, the replication decryption changeover processing is performed. The replication decryption changeover processing means to perform the processing of the flow chart showing the procedure of performing the encryption and decryption of the volume on the management computer by the user who uses the volume as the first embodiment of the present invention, which is explained in FIGS. 3A and 3B. When the data replication is treated as the restoration job, the host which performs the data replication is made to recognize the encrypted volume without decrypting the volume. Then, it is to proceed to step 813.

In step 813, the data replication program 523 is started actually to the data restoration, and the processing is ended after the data restoration is completed.

Thereby, it becomes possible to realize a data restoration environment according to the user's job even on a file level or on a volume level by using the changeover of the encryption apparatus. Further, it becomes possible to perform the restoration without showing contents of a volume to the user whose job is to perform the data restoration.

In addition, it is obvious that the present invention is not limited to the above mentioned embodiments of the present invention but it can be subjected appropriately to any other structure within the scope of claims of the present invention.

Having described preferred embodiments of the present invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A computer system comprising a computer which executes a job, a storage apparatus which is connected with said computer and which has a memory area for storing encrypted data which is encrypted to data used by said computer, a encryption-decryption apparatus which performs encryption-decryption to the data stored in said storage apparatus and a management computer which manages said computer, said storage apparatus and said encryption-decryption apparatus, wherein said management computer
judges the necessity of the decryption of the data which is stored per each job in said storage apparatus to an execution request for the job of said computer;
decrypts said encrypted data and sets up a first path between said computer and said storage apparatus for providing said computer with the decrypted data to an execution request for a first job from the computer;
sets up a second path for providing said computer with said encrypted data without performing the decryption to an execution request for a second job from the computer, and
said computer acquires the data relating to said first job in a decrypted state through said first path and acquires the data of an encrypted state through said second path to said execution request for the second job.

2. A computer system according to claim 1, wherein said second path is a different path from the path up to said storage apparatus which is set up through the encryption-decryption apparatus according to the job of the computer for the encrypted data which is stored in said storage apparatus, and said computer acquires the data relating to said second job without passing through said encryption-decryption apparatus.

3. A computer system according to claim 1, wherein it is judged whether or not a state of said management computer to said encryption-decryption apparatus is set so as not to decrypt the data according to said memory area when the decryption is not performed to the data of said memory area by the first job or second job of said computer; said processing without decryption is chosen when the state of said management computer to said encryption-decryption apparatus is set so as not to decrypt the data; and a path is chosen for connecting said storage apparatus and said computer by the path where the data is not decrypted when it is not possible to choose said processing without decryption.

4. A computer system according to claim 3, wherein it is judged whether or not the state of said management computer to said encryption-decryption apparatus is set so as not to perform the encryption according to said memory area when the encryption is not performed to the data of said memory area by the first job or second job of said computer; said processing without encryption is chosen when the state of said management computer to said encryption-decryption apparatus is set so as not to encrypt the data; and a path is chosen for connecting said storage apparatus and said computer by the path where the data is not encrypted when it is not possible to choose said processing without encryption.

5. A computer system according to claim 1, wherein the second job of said computer is a data replication, and when the data replication is performed by said computer, setting of said management computer to said encryption-decryption apparatus is the one which replicates said data separately on said memory area as is encrypted without decrypting the data.

6. A computer system according to claim 5, wherein due to the setting of said management computer to said encryption-decryption apparatus, a file in the data of said memory area is detected; information of said file is transmitted to the computer which performs the data replication when said data replication is performed per unit of said memory area; and the computer which performs said data replication reflects the information of said file to information of the replicated memory area.

7. A computer system according to claim 6, wherein due to the setting of said management computer to said encryption-decryption apparatus; when data detection is performed by said computer in order to detect a portion of data out of the data after the replication of a volume and when a unit of the data detection is a file, the second job of said computer detects the file in the data of said volume; information of said file is transmitted to the computer which performs the data detection; the computer which performs said data detection makes the data replication information of the replicated memory area correspond to the information of said file; and said file is transmitted to a request source of the data detection.

8. A computer system according to claim 1, wherein said encryption-decryption apparatus is comprised in either said computer or said storage apparatus, or on the path between said computer and said storage apparatus.

9. A computer system according to claim 4, wherein the processing for judging whether or not it is said setting of no decryption and choosing the connection by said path of no decryption; and also judging whether or not it is said setting of no encryption and choosing the connection by said path of no encryption, is performed based on the information of said management computer.

10. A computer system according to claim 2, wherein it is judged by said management computer in accordance with the first job or second job of said computer whether or not it is possible to set yes/no of execution of the encryption and the decryption to the data by changing over the path between said computer and said storage apparatus; when said setting is possible, a command to carry out said setting is given by said management computer to a switch which changes over the path between said computer and said storage apparatus; and the changeover of said path is performed by said switch for carrying said setting.

11. A computer system according to claim 3, wherein said judgment whether or not the setting is the one without decryption is made based on management information which manages yes/no of execution of the decryption to the data in accordance with the first job or second job of said computer and a combination of requested said memory areas of said first job or second job so as to judge by said management computer whether or not said combination is the setting of no decryption of the data, and with respect to the choice of connecting by said path of no decryption: when it is judged by said management computer that said combination is the setting of no decryption of the data, a command of not executing the decryption is given by said management computer to the encryption-decryption apparatus which changes over and executes respectively yes/no of the encryption and decryption of the data; processing without decryption of the data which has been encrypted by said encryption-decryption apparatus and has been saved in said memory area is chosen; and when it is not possible to choose said processing without decryption to the encryption-decryption apparatus which can not change over and execute respectively yes/no of the encryption and decryption of the data, a command is given by said management computer to the switch which changes over the path between said computer and said storage apparatus; and the path is chosen by said switch for connecting said storage apparatus and said computer by the path of no decryption of the data.

12. A computer system according to claim 4, wherein said judgment whether or not the setting is the one without encryption is made based on the management information which manages yes/no of execution of the encryption to the data in accordance with the first job or second job of said computer and the combination of requested said memory areas of said first job or second job so as to judge by said management computer whether or not said combination is the setting of no encryption of the data, and with respect to the choice of connecting by said path of no encryption: when it is judged by said management computer that said combination is the setting of no encryption of the data, a command of not executing the encryption is given by said management computer to the encryption-decryption apparatus which changes over and executes respectively yes/no of the encryption and decryption of the data; processing without encryption of the data which has been encrypted by said encryption-decryption apparatus and has been saved in said memory area is chosen; and when it is not possible to choose said processing without encryption to the encryption-decryption apparatus which can not change over and execute respectively yes/no of the encryption and decryption of the data, a command is given by said management computer to the switch which changes over the path between said computer and said storage apparatus; and the path is chosen by said switch for connecting said storage apparatus and said computer by the path of no encryption of the data.

13. A management computer to manage a computer which executes a job, a storage apparatus which is connected with said computer and which has a memory area for storing encrypted data which is encrypted to data used by said computer and a encryption-decryption apparatus which performs encryption-decryption to the data stored in said storage apparatus comprising:
a communication interface which is connected with said computer, said storage apparatus and said encryption-decryption apparatus through a network and which performs communication with the outside; and
a control portion which is connected with said communication interface and which is responsible for controlling, wherein said control portion
judges the necessity of the decryption of the data to be stored per each job in said storage apparatus to an execution request for the job of said computer;
decrypts said encrypted data and sets up a first path between said computer and said storage apparatus for providing said computer with the decrypted data to an execution request for a first job from the computer;
sets up a second path for providing said computer with said encrypted data without performing the decryption to an execution request for a second job from the computer; and
makes said computer acquire the data relating to said first job in a decrypted state through said first path and acquire the data of an encrypted state through said second path to the execution request for said second job.

14. A management computer according to claim 13, wherein said second path is a different path from the path up to said storage apparatus which is set up through the encryption-decryption apparatus according to the job of the computer for the encrypted data which is stored in said storage apparatus, and said computer is made to acquire the data relating to said second job without passing through said encryption-decryption apparatus.

15. A management computer according to claim 13, wherein said control portion judges whether or not said combination is the setting of no decryption of the data based on management information which manages yes/no of the execution of the decryption to the data in accordance with the first job or second job of said computer and a combination of requested said memory areas of said fist job or second job; said control portion commands said encryption-decryption apparatus not to execute the decryption when it is judged that said combination is the setting of no decryption of the data; and said control means gives a command to a switch which changes over the path between said computer and said storage apparatus such that said storage apparatus and said computer are connected by the path of no decryption of the data when it is not possible to perform said processing without decryption to the encryption-decryption apparatus which can not change over and execute respectively yes/no of the encryption and decryption of the data.

16. A management computer according to claim 13, wherein said control portion judges whether or not said combination is the setting of no encryption of the data based on management information which manages yes/no of the execution of the encryption to the data in accordance with the first job or second job of said computer and the combination of requested said memory areas of said first job or second job; said control portion commands said encryption-decryption apparatus not to execute the encryption when it is judged that said combination is the setting of no encryption of the data; and said control means gives a command to the switch which changes over the path between said computer and said storage apparatus such that said storage apparatus and said computer are connected by the path of no encryption of the data when it is not possible to perform said processing without encryption to the encryption-decryption apparatus which can not change over and execute respectively yes/no of the encryption and decryption of the data.

17. A data management method of performing management by a management computer to a computer which executes a job, a storage apparatus which is connected with said computer and which has a memory area for storing encrypted data which is encrypted to data used by said computer and a encryption-decryption apparatus which performs encryption-decryption to the data stored in said storage apparatus, wherein said management computer.
judges the necessity of the decryption of the data to be stored per each job in said storage apparatus to an execution request for the job of said computer;
decrypts said encrypted data and sets up a first path between said computer and said storage apparatus for providing said computer with the decrypted data to an execution request for a first job from the computer;
sets up a second path for providing said computer with said encrypted data without performing the decryption to an execution request for a second job from the computer; and
makes said computer acquire the data relating to said first job in a decrypted state through said first path and acquire the data of an encrypted state through said second path to said execution request for the second job.
